(19) United States
(12) Patent Application Publication
(10) Pub. No.: US 2012/0158248 A1
(43) Pub. Date: Jun. 21, 2012

(54) VEHICLE SAFETY SENSOR CONTROL DEVICE

(75) Inventors: Jung Hee Suk, Daejeon (KR); Chun-Gi Lyuh, Daejeon (KR); Ik Jae Chun, Daejeon (KR); Sanghun Yoon, Daejeon (KR); Tae Moon Roh, Daejeon (KR)

(73) Assignee: Electronics and Telecommunications Research Institute, Daejeon (KR)

(21) Appl. No.: 13/243,026

(22) Filed: Sep. 23, 2011

(30) Foreign Application Priority Data
Dec. 16, 2010 (KR) 10-2010-0129218

(51) Int. Cl. B60R 21/01

(52) U.S. Cl. 701/45

(57) ABSTRACT

A vehicle safety sensor control device is provided. The vehicle safety sensor control device may include a slope sensor portion sensing a slope of vehicle; a safety sensor portion sensing running safety information for a vehicle safety running; a sensing control angle generation portion sensing a sensing control angle from the sensed slope; and a safety sensor control portion controlling up and down direction angles of the safety sensor on the basis of a horizontal plane of vehicle depending on the sensing control angle.

### CROSS-REFERENCE TO RELATED APPLICATIONS

This U.S. non-provisional patent application claims priority under 35 U.S.C. §119 of Korean Patent Application No. 10-2010-0129218, filed on Dec. 16, 2010, the entire contents of which are hereby incorporated by reference.

### BACKGROUND

The present inventive concept herein relates to vehicle safety sensor control systems, and more particularly, to a vehicle safety sensor control device controlling a vehicle safety sensor.

Safety sensors installed for a vehicle safety running may include, for example, a radar sensor, an infrared sensor, an image sensor, etc. Generally, safety sensors operate on the assumption that vehicles run on a flat road. However, the road may have various slopes such as an uphill infection section, a downhill infection section and a speed bump. Thus, while a slope of vehicle varies depending on a slope of road, blind spots may occur in these safety sensors operating on the basis of a flat road depending on changes in a sensing direction, a sensing area and a sensing distance.

### SUMMARY

Embodiments of the inventive concept provide a vehicle safety sensor control device. The vehicle safety sensor control device may include a slope sensor portion sensing a slope of vehicle; a safety sensor portion sensing running safety information for a vehicle safety running; a sensing control angle generation portion sensing a sensing control angle from the sensed slope; and a safety sensor control portion controlling up and down direction angles of the safety sensor on the basis of a horizontal plane of vehicle depending on the sensing control angle.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention.

FIG. 1 is a drawing illustrating a structure of vehicle safety sensor control device in accordance with some embodiments of the inventive concept.

FIG. 2 is a drawing illustrating a sensing control angle of infection sections in which a slope is changed in accordance with some embodiments of the inventive concept.

FIG. 3 is a drawing illustrating safety sensors in accordance with some embodiments of the inventive concept.

FIGS. 4A and 4B are drawings illustrating sensing direction change of vehicle safety sensor in an infection section where an uphill slope increases in accordance with some embodiments of the inventive concept.

FIGS. 5A and 5B are drawings illustrating sensing direction change of vehicle safety sensor in an infection section where an uphill slope decreases in accordance with some embodiments of the inventive concept.

FIGS. 6A and 6B are drawings illustrating sensing direction change of vehicle safety sensor in an infection section where a downhill slope increases in accordance with some embodiments of the inventive concept.

FIGS. 7A and 7B are drawings illustrating sensing direction change of vehicle safety sensor in an infection section where a downhill slope decreases in accordance with some embodiments of the inventive concept.

FIG. 8 is a drawing illustrating a method of controlling a vehicle safety sensor of vehicle safety sensor control device.

### DETAILED DESCRIPTION OF THE EMBODIMENTS

Preferred embodiments of the inventive concept will be described below in more detail with reference to the accompanying drawings. The embodiments of the inventive concept may, however, be embodied in different forms and should not be constructed as limited to the embodiments set forth herein. Rather, these embodiments are provided so that this disclosure will be thorough and complete, and will fully convey the scope of the inventive concept to those skilled in the art. Like numbers refer to like elements throughout.

It will be understood that when an element is referred to as being “connected” or “coupled” to another element, it can be directly connected or coupled to the other element or intervening elements may be present. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

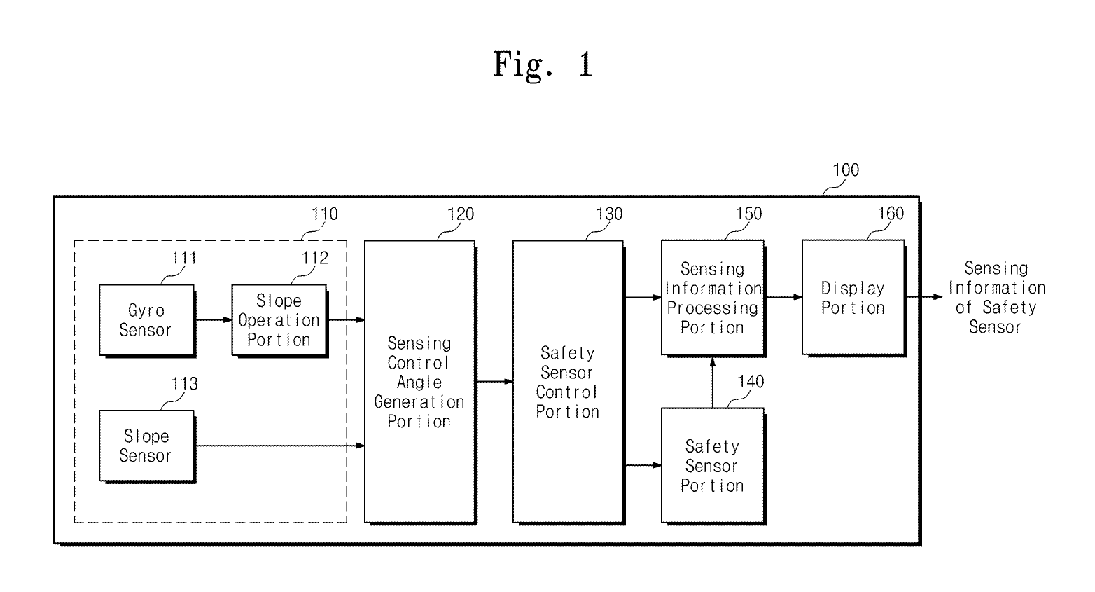

FIG. 1 is a drawing illustrating a structure of vehicle safety sensor control device in accordance with some embodiments of the inventive concept.

Referring to FIG. 1, a vehicle safety sensor control device 100 includes a slope sensor portion 110, a sensing control angle generation portion 120, a safety sensor control portion 130, a safety sensor portion 140, a sensing information processing portion 150 and a display portion 160. The vehicle safety sensor control device 100 may be installed in a vehicle.

The slope sensor portion 110 senses a slope of vehicle. The slope sensor portion 110 senses slope change of vehicle on the basis of a horizontal plane (for example, a plane in which a slope of vehicle is 0 degree or a line connecting axes of vehicle) of vehicle.

The slope sensor portion 110 includes a gyro sensor 111, a slope operation portion 112 and a slope sensor 113.

The gyro sensor 111 is attached to a vehicle and senses an angular speed in accordance with vehicle running. The gyro sensor 111 outputs the sensed angular speed to the slope operation portion 112.

The slope operation portion 112 receives an angular speed and converts the angular speed into a slope of vehicle. The slope operation portion 112 outputs the converted slope, that is, a slope value to the sensing control angle generation portion 120.

The slope sensor 113 is attached to a vehicle and senses a slope of vehicle. The slope sensor 113 outputs the sensed slope, that is, a slope value to the sensing control angle generation portion 120.

The slope sensor portion 110 may include one of the gyro sensor 111 and the slope sensor 113.

The sensing control angle generation portion 120 generates a sensing control angle through a differential operation of a slope of vehicle. The sensing control angle generation portion 120 is an operator differentiating a slope in accordance with vehicle running. The sensing control angle generation portion 120 may obtain a differential value through a differential operation of slope. The sensing control angle generation portion 120 generates a sensing control angle for controlling sensing directions of safety sensors of the safety sensor portion 140 on the basis of the differential value. The sensing control angle varies in proportion to the differential value. The sensing control angle generation portion 120 outputs the sensing control angle to the safety sensor control portion 130. The safety sensor control portion 130 outputs a sensor control signal for controlling a sensing direction of each of the safety sensors of the safety sensor portion 140 to the safety sensor portion 140 based on the sensing control angle.

Also, the safety sensor control portion 130 may output information about a slope value, a differential value and a sensing control angle to the sensing information processing portion 150.

The safety sensor portion 140 includes at least one safety sensor sensing information for safety running of vehicle. The safety sensor portion 140 may include, for example, a safety sensor such as a radar sensor, a laser sensor, an infrared sensor, an image sensor, etc. The safety sensor portion 140 may provide information sensed through sensing lanes and objects (animals, persons and other vehicles) around a vehicle to a driver. The safety sensor portion 140 may be divided into a front safety sensor, a side safety sensor and a rear safety sensor according to a sensing direction (or location) of each of the safety sensors.

The safety sensor portion 140 may control a sensing direction of each of safety sensors through sensor control information of the safety sensor control portion 130. For example, the safety sensor portion 140 may control an angle of sensing direction in an up and down direction according to a sensing control angle.

The safety sensor portion 140 may minimize blind spots of safety sensors by controlling a sensing direction of safety sensor in a slope section of road. The safety sensor portion 140 outputs sensing information sensed through each of the safety sensors to the sensing information processing portion 150.

The sensing information processing portion 150 generates an image signal through a signal processing of the input information. As an illustration, the sensing information processing portion 150 convert sensor state information of the safety sensor sensed through each of the safety sensors into an image signal and then outputs the image signal to the display portion 160. Also, the sensing information processing portion 150 converts running information of vehicle and sensor state information obtained based on a slope or a differential value into an image signal and then outputs the image signal to the display portion 160.

The sensing information processing portion 150 may generate an alarm signal if a dangerous situation based on sensing information occurs. The sensing information processing portion 150 may output the alarm signal to the display portion 160. Also, to generate an alarm signal through a speaker (not shown), the sensing information processing portion 150 may output the alarm signal to a speaker.

The display portion 160 outputs an image signal through a display screen. The display portion 160 outputs sensor state information of the safety sensor of which a sensing direction is controlled according to the image signal. The display portion 160 displays information about running information of vehicle according to the image signal.

Consequently, the present inventive concept may minimize blind spots of safety sensor which may occur in infection sections of road by controlling a sensing direction of each of safety sensors using a slope of vehicle.

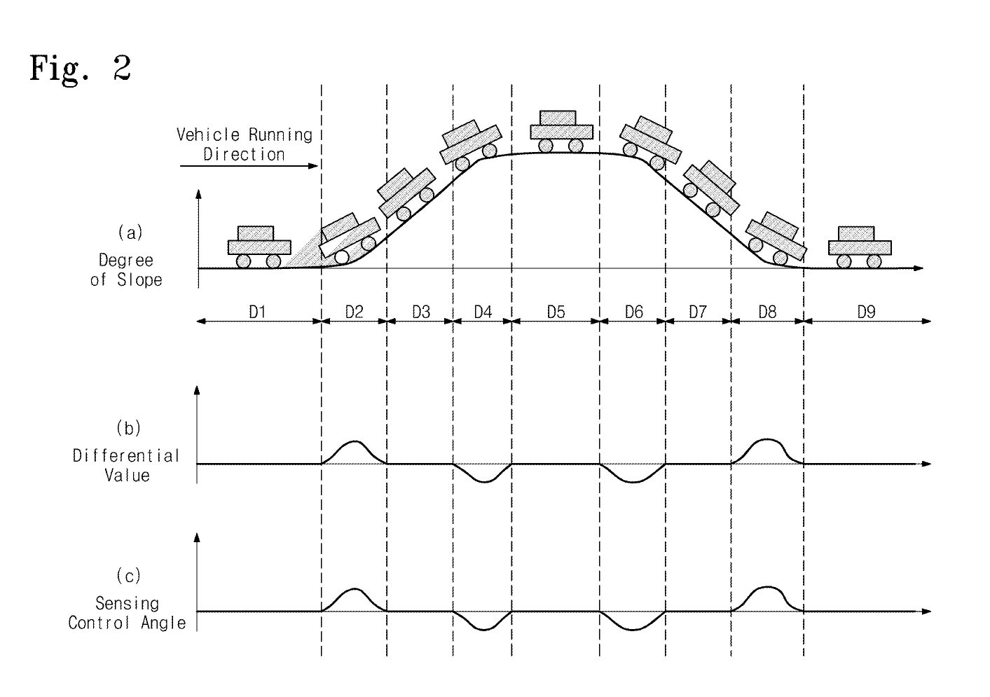

FIG. 2 is a drawing illustrating a sensing control angle of infection sections in which a slope is changed in accordance with some embodiments of the inventive concept.

Referring to FIG. 2, a road is illustrated in (a). A D1 section, a D5 section and a D9 section are horizontal sections. A D2 section is an infection section and an uphill slope increases in the D2 section. A D3 section is a section having a fixed slope and an uphill slope in the D3 section is fixed. A D4 is an infection section and an uphill slope decreases in the D4 section. A D6 is an infection section and a downhill slope increases in the D6. The D7 is a section having a fixed slope and a downhill slope in the D7 section is fixed. A D8 is an infection section and a downhill slope decreases in the D8 section.

A sensing direction (or area) which safety sensors of vehicle sense should be changed depending on a slope of road. In particular, the safety sensor control portion 130 should control a sensing direction of safety sensors of vehicle in an infection section of road.

Differential values calculated in the sensing control angle generation portion 120 are illustrated in (b). The sensing control angle generation portion 120 may obtain differential values through a differentiation of slope output in the slope sensor portion 110. It may be checked that differential values are changed depending on a slope change in infection sections (e.g., D2, D4, D6 and D8 sections).

A sensing control angle θ output from the sensing control angle generation portion 120 is illustrated in (c). The sensing control angle generation portion 120 may generate a sensing control angle for controlling a safety sensor based on a differential value. The safety sensor control portion 130 may control sensing directions of safety sensors depending on a sensing control angle.

Infection sections (e.g., D2, D4, D6 and D8 sections) are sections in which a blind spot of safety sensor may occur in a sensing direction. Thus, the vehicle safety sensor control device 100 minimizes occurrence of blind spot of safety sensor by controlling a sensing direction of safety sensor based on a value obtained by differentiating a slope of vehicle in an infection section.

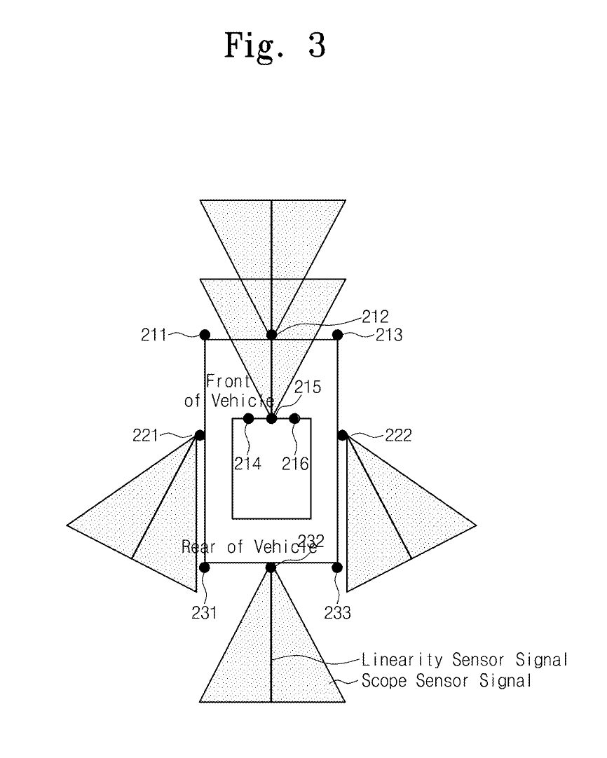

FIG. 3 is a drawing illustrating safety sensors in accordance with some embodiments of the inventive concept.

Referring to FIG. 3, the safety sensor portion 140 includes safety sensors 211 through 216, 221, 222 and 231 through 233.

Front safety sensors 211 through 216 sense the front of vehicle. The front safety sensors may be attached to a front portion of vehicle.

Side safety sensors 221 and 222 sense the side of vehicle. The side safety sensors 221 and 222 may be attached to both sides of vehicle.

Rear safety sensors 231, 232 and 233 sense the rear of vehicle. The rear safety sensors 231, 232 and 233 may be attached to the rear of vehicle.

The safety sensors 211 through 216, 221, 222 and 231 through 233 may sense information for safe running of vehicle from the outside of vehicle. The safety sensors 211 through 216, 221, 222 and 231 through 233 may be constituted by at least one of a laser sensor, an infrared sensor and an image sensor.

The safety sensors 211 through 216, 221, 222 and 231 through 233 may be embodied by various sensors and may sense a lane of road or objects (animals, persons and other vehicles) around a vehicle depending on the type of sensor embodied.

Also, the safety sensors 211 through 216, 221, 222 and 231 through 233 may generate a linearity sensor signal and a scope sensor signal. The linearity sensor signal is a signal sensing a sensing direction of sensor and the scope sensor signal is a signal being generated around the linearity sensor signal. Thus, the vehicle safety sensor control device 100 may control sensing directions of the linearity sensor signal and the scope sensor signal by changing a sensing control angle of the safety sensors 211 through 216, 221, 222 and 231 through 233 depending on a slope of vehicle.

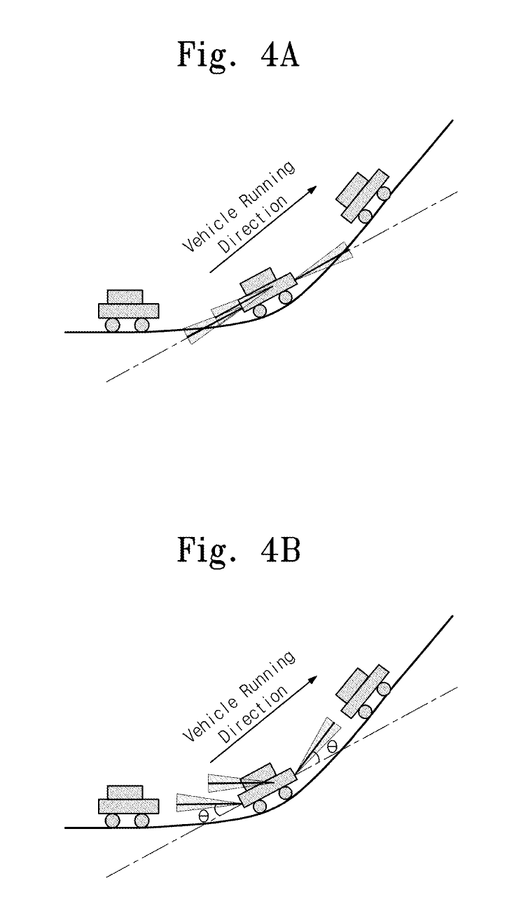

FIGS. 4A and 4B are drawings illustrating sensing direction change of vehicle safety sensor in an infection section where an uphill slope increases accordance with some embodiments of the inventive concept.

Referring to FIG. 4A, a sensing direction of safety sensors that is not controlled is illustrated. A vehicle may run on an infection section (e.g., D2 section of FIG. 2) in which an uphill slope increases. Safety sensors of vehicle have a fixed sensing direction on the basis of a flat road. At this time, blind spots of safety sensors may occur.

Referring to FIG. 4B, a controlled sensing direction of safety sensors is illustrated. A vehicle may run on an infection section in which an uphill slope increases. The safety sensor control portion 130 may control a sensing direction of safety sensors upwardly by a sensing control angle θ. At this time, the safety sensors change a sensing direction upwardly by the sensing control angle θ on the basis of a horizontal plane of vehicle.

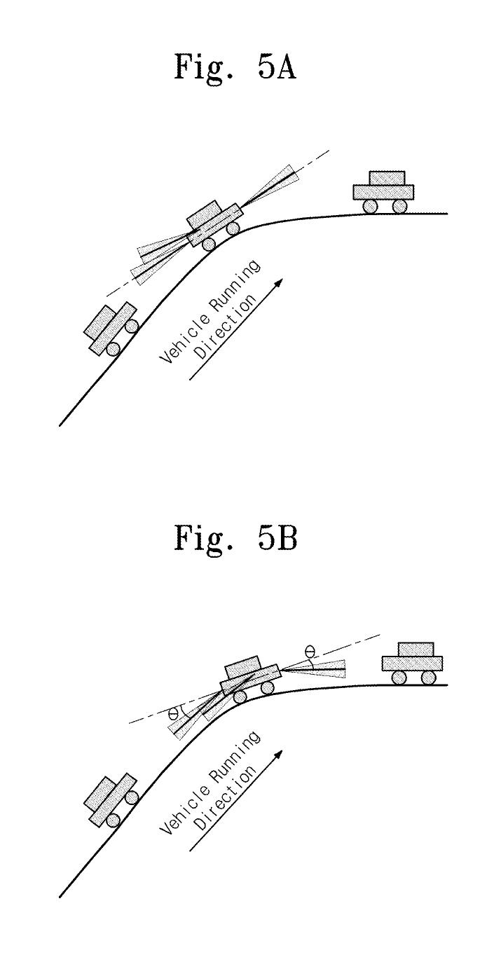

FIGS. 5A and 5B are drawings illustrating sensing direction change of vehicle safety sensor in an infection section where an uphill slope decreasesin accordance with some embodiments of the inventive concept.

Referring to FIG. 5A, a sensing direction of safety sensors that is not controlled is illustrated. A vehicle may run on an infection section (e.g., D4 section of FIG. 2) in which an uphill slope decreases. Safety sensors of vehicle have a fixed sensing direction on the basis of a flat road. At this time, blind spots of safety sensors may occur.

Referring to FIG. 5B, a controlled sensing direction of safety sensors is illustrated. A vehicle may run on an infection section in which an uphill slope decreases. The safety sensor control portion 130 may control a sensing direction of safety sensors downwardly by a sensing control angle θ. At this time, the safety sensors change a sensing direction downwardly by the sensing control angle θ on the basis of a horizontal plane of vehicle.

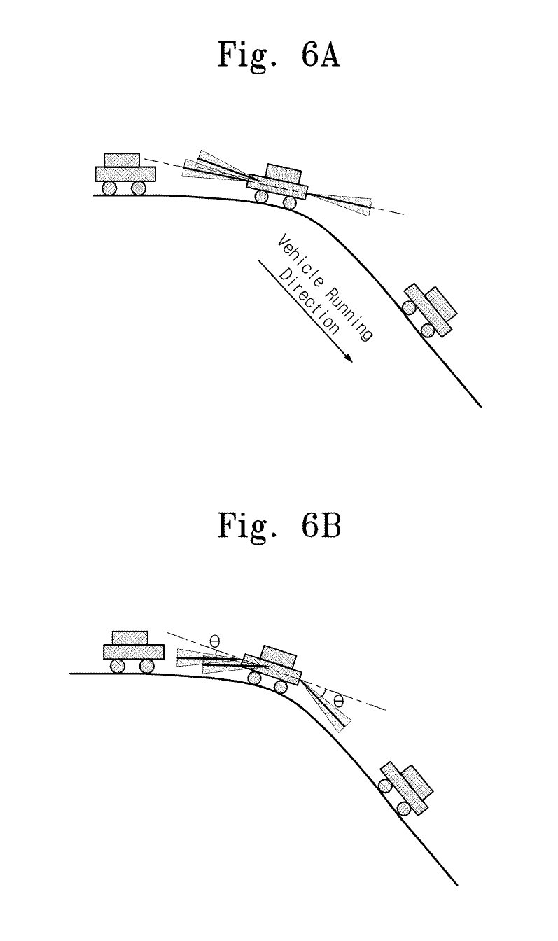

FIGS. 6A and 6B are drawings illustrating sensing direction change of vehicle safety sensor in an infection section where a downhill slope increases accordance with some embodiments of the inventive concept.

Referring to FIG. 6A, a sensing direction of safety sensors that is not controlled is illustrated. A vehicle may run on an infection section (e.g., D6 section of FIG. 2) in which a downhill slope increases. Safety sensors of vehicle have a fixed sensing direction on the basis of a flat road. At this time, blind spots of safety sensors may occur.

Referring to FIG. 6B, a controlled sensing direction of safety sensors is illustrated. A vehicle may run on an infection section in which a downhill slope increases. The safety sensor control portion 130 may control a sensing direction of safety sensors upwardly by a sensing control angle θ. At this time, the safety sensors change a sensing direction downwardly by the sensing control angle θ on the basis of a horizontal plane of vehicle.

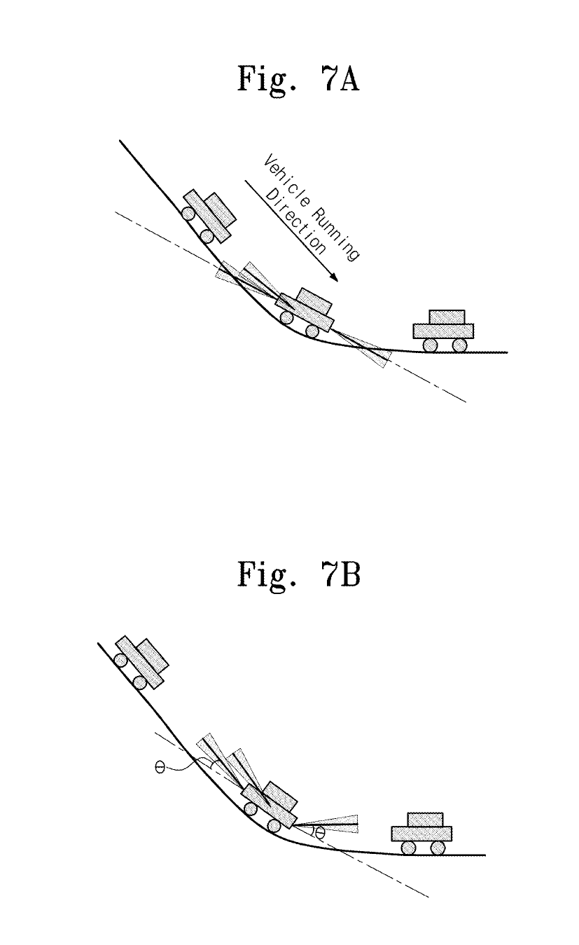

FIGS. 7A and 7B are drawings illustrating sensing direction change of vehicle safety sensor in an infection section where a downhill slope decreases in accordance with some embodiments of the inventive concept.

Referring to FIG. 7A, a sensing direction of safety sensors that is not controlled is illustrated. A vehicle may run on an infection section (e.g., D8 section of FIG. 2) in which a downhill slope decreases. Safety sensors of vehicle have a fixed sensing direction on the basis of a flat road. At this time, blind spots of safety sensors may occur.

Referring to FIG. 7B, a controlled sensing direction of safety sensors is illustrated. A vehicle may run on an infection section in which a downhill slope decreases. The safety sensor control portion 130 may control a sensing direction of safety sensors downwardly by a sensing control angle θ. At this time, the safety sensors change a sensing direction upwardly by the sensing control angle θ on the basis of a horizontal plane of vehicle.

Referring to FIGS. 4A through 7B, blind spots may be minimized by controlling a sensing direction of safety sensor in each infection section.

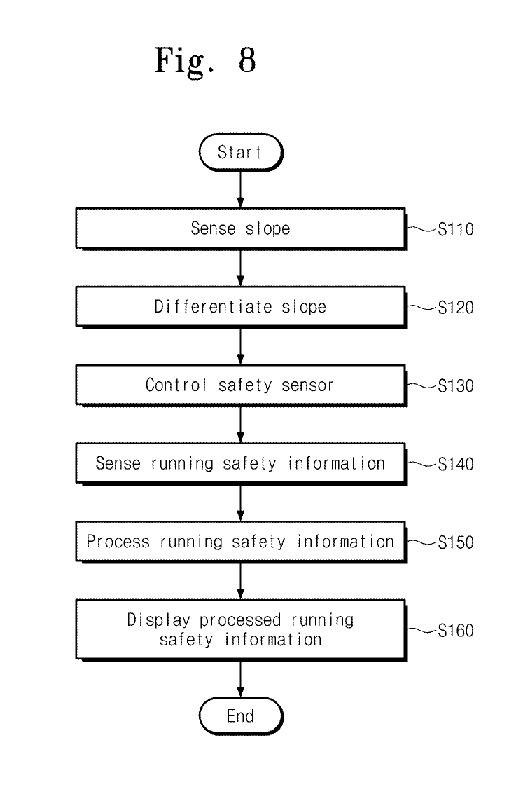

FIG. 8 is a drawing illustrating a method of controlling a vehicle safety sensor of vehicle safety sensor control device.

Referring to FIG. 8, in a step of S110, the slope sensor portion 110 senses a slope of vehicle. The slope sensor portion 110 includes a sensor for generating at least one slope sensing. The slope sensor portion 110 outputs the sensed slope of vehicle to the control angle generation portion 120. At this time, if the slope sensor portion 110 includes two or more sensors for slope sensing, the slopes of vehicle from each of the sensors may be output to the differential operation portion 120.

In a step of S120, the sensing control angle generation portion 120 differentiates a slope of vehicle. The sensing control angle generation portion 120 obtains a differential value through a slope differential operation.

The sensing control angle generation portion 120 may generate a sensing control angle using a differential value. The sensing control angle generation portion 120 outputs the sensing control angle to the safety sensor control portion 130.

In a step of S130, the safety sensor control portion 130 may control sensing directions of safety sensors of the safety sensor portion 140 depending on a sensing control angle.

As an illustration, the safety sensor control portion 130 controls a sensing direction of safety sensor in an infection section where an uphill slope increases upwardly by a sensing control angle. The safety sensor control portion 130 controls a sensing direction of safety sensor in an infection section where an uphill slope decreases downwardly by a sensing control angle. The safety sensor control portion 130 controls a sensing direction of safety sensor in an infection section where a downhill slope increases downwardly by a sensing control angle. The safety sensor control portion 130 controls a sensing direction of safety sensor in an infection section where a downhill slope decreases upwardly by a sensing control angle.

Also, even in infection sections, the safety sensor control portion 130 minimizes occurrence of blind spots due to a slope of road through a sensing control angle being changed depending on a slope differential value.

The safety sensor control portion 130 outputs a sensor direction control signal to the safety sensor portion 140 to control safety sensors.

In a step of S140, the safety sensor portion 140 senses running safety information through safety sensors. The safety sensor portion 140 outputs the running safety information to the sensing information processing portion 150. The safety sensor portion 140 may sense running safety information by controlling sensing directions of safety sensors depending on a sensor direction control signal. The safety sensor portion 140 outputs the sensed running safety information to the sensing information processing portion 150.

In a step of S150, the sensing information processing portion 150 processes safety running information. The sensing information processing portion 150 may process the safety running information in the form of image signal to display the safety running information. The sensing information processing portion 150 outputs the running safety information processed in the form of image signal to the display portion 160. The safety running information includes sensor state information and may include running information according to a slope of vehicle.

In a step of S160, the display portion 160 displays the safety running information.

Consequently, the vehicle safety sensor control device 100 may minimize blind spots of safety sensor caused by a running of vehicle by controlling a sensing direction of each of safety sensors with a sensing angle in proportion to a differential value of a slope of vehicle.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents. Therefore, the above-disclosed subject matter is to be considered illustrative, and not restrictive.

What is claimed is:

1. A vehicle safety sensor control device comprising:
a slope sensor portion sensing a slope of vehicle;
a safety sensor portion sensing running safety information for a vehicle safety running;
a sensing control angle generation portion sensing a sensing control angle from the sensed slope; and
a safety sensor control portion controlling up and down direction angles of the safety sensor on the basis of a horizontal plane of vehicle depending on the sensing control angle.

2. The vehicle safety sensor control device of claim 1, wherein the sensing control angle generation portion generates a differential value through a differentiation of the sensed slope and generates a sensing control angle in proportion to the differential value.

3. The vehicle safety sensor control device of claim 2, wherein the safety sensor control portion controls a sensing direction of the safety sensor portion upwardly on the basis of a horizontal plane of the vehicle if the differential value increases and controls a sensing direction of the safety sensor portion downwardly on the basis of a horizontal plane of the vehicle if the differential value decreases.

4. The vehicle safety sensor control device of claim 3, wherein the safety sensor control portion controls a sensing direction of the safety sensor upwardly by the sensing control angle if the vehicle runs on an infection section in which an uphill slope increases.

5. The vehicle safety sensor control device of claim 3, wherein the safety sensor control portion controls a sensing direction of the safety sensor downwardly by the sensing control angle if the vehicle runs on an infection section in which an uphill slope decreases.

6. The vehicle safety sensor control device of claim 3, wherein the safety sensor control portion controls a sensing direction of the safety sensor downwardly by the sensing control angle if the vehicle runs on an infection section in which a downhill slope increases.

7. The vehicle safety sensor control device of claim 3, wherein the safety sensor control portion controls a sensing direction of the safety sensor upwardly by the sensing control angle if the vehicle runs on an infection section in which a downhill slope decreases.

8. The vehicle safety sensor control device of claim 1, further comprising:
a sensing information processing portion processing running safety information received through the safety sensor; and
a display portion displaying the processed running safety information.

9. The vehicle safety sensor control device of claim 8, wherein the safety sensor control portion outputs the slope and the differential value to the sensing information processing portion.

10. The vehicle safety sensor control device of claim 9, wherein the sensing information processing portion outputs the running information and the sensor state information obtained through a signal processing of the slope and the differential value to the display portion.

11. The vehicle safety sensor control device of claim 1, wherein the slope sensor portion comprises a slope sensor sensing a slope of vehicle.

12. The vehicle safety sensor control device of claim 1, wherein the slope sensor portion further comprises:
a gyro sensor sensing an angular speed according to a running of vehicle; and
a slope operation portion operating a slope from the angular speed.

13. The vehicle safety sensor control device of claim 1, wherein the safety sensor is used in a vehicle and comprises at least one of a laser sensor, a radar sensor and an image sensor.

14. The vehicle safety sensor control device of claim 1, wherein the safety sensor comprises at least one of a front safety sensor sensing the front of vehicle, a rear safety sensor sensing the rear of vehicle and a side safety sensor sensing the sides of vehicle.
